(19) United States
(12) Patent Application Publication
(10) Pub. No.: US 2020/0276862 A1
(43) Pub. Date: Sep. 3, 2020

(54) VEHICLE WHEEL

(71) Applicant: HONDA MOTOR CO., LTD., Tokyo (JP)

(72) Inventor: Youichi KAMIYAMA, Wako-shi, Saitama (JP)

(21) Appl. No.: 16/760,278

(22) PCT Filed: Oct. 25, 2018
(86) PCT No.: PCT/JP2018/039583

§ 371 Date: Apr. 29, 2020

(30) Foreign Application Priority Data
Nov. 6, 2017 (JP) 2017-213550

(51) Int. Cl. B60B 21/02; B60B 21/12

(52) U.S. Cl. CPC B60B 21/02; B60B 21/12

(57) ABSTRACT

A vehicle wheel that is capable of preventing water, moisture, or the like in a tire air chamber from entering an auxiliary air chamber through a communicating hole. The vehicle wheel includes: an auxiliary air chamber member as a Helmholtz resonator attached onto an outer peripheral surface of a well portion in the tire air chamber; a first and second vertical walls provided respectively at a first and a second rising portions of a rim forming the well portion, wherein the auxiliary air chamber member includes: an auxiliary air chamber inside thereof, and a communication hole allowing the auxiliary air chamber to communicate with the tire air chamber, wherein the communication hole is placed at an end of the of the auxiliary air chamber member along a circumferential axis of the vehicle wheel, and a clearance is formed between the communication hole and the vehicle wheel.

### TECHNICAL FIELD

The present invention relates to a wheel for a vehicle such as an automobile.

### BACKGROUND ART

A well portion-known conventional art includes an auxiliary air chamber member that works as a Helmholtz resonator in a tire air chamber and is fixed to an outer peripheral surface of a well portion.

The auxiliary air chamber member disclosed by, for example, Patent Literature 1 includes a tube provided at a circumferential end of a resonator body, wherein the tube includes a communication hole whose first circumferential end is open to the tire air chamber and whose second circumferential end communicates with an inside of an auxiliary air chamber.

### CITATION LIST

### Patent Literature

Patent Literature 1: Japanese Patent No. 5978166

### SUMMARY OF INVENTION

### Technical Problem

However, the auxiliary air chamber member disclosed in Patent Literature 1 has the communication hole facing the tire air chamber been in contact with a wheel rim surface at a lower end of the first circumferential end of the first circumferential end of this hole. For this reason, water condensed in the tire air chamber, moisture, and a liquid of a puncture repair agent might enter through the communication hole that comes into contact with the wheel rim surface and remain in the auxiliary air chamber.

This might result in reduction of an inner volume of the auxiliary air chamber member of the auxiliary air chamber, causing deterioration in a noise reduction performance (t deterioration in a performance of reducing a road noise due to air column resonance); and further, deterioration of wheel balance.

The present invention is presented in view of the above problem, and it is an object of the present invention to provide a vehicle wheel capable of preventing water, moisture, and the like included in the tire air chamber from entering through the communication hole into the auxiliary air chamber.

### Solution to Problem

In order to achieve the above object, the present invention provides a vehicle wheel that is provided as a Helmholtz resonator with an auxiliary air chamber member attached. to an outer peripheral surface of a well portion in a tire air chamber, wherein the vehicle wheel includes a rim forming the well portion; a first vertical wall provided at a first rising portion of the rim; and a second vertical wall provided at a second rising portion of the rim, wherein the auxiliary air chamber member includes an auxiliary air chamber and. a communication hole allowing the auxiliary air chamber to communicate with the tire air chamber, wherein the communication hole is placed at a first end of the of the auxiliary air chamber member formed along a circumferential direction of the vehicle wheel, and wherein a clearance is formed between the communication hole and the vehicle wheel.

### Effect of Invention

The present invention can provide a vehicle wheel capable of preventing water, moisture, and the like in the tire air chamber from entering the auxiliary air chamber through the communication hole.

### BRIEF DESCRIPTION OF DRAWINGS

FIG. 1 is a perspective view of a vehicle wheel according to an embodiment of present invention.

FIG. 2 is a perspective view of the auxiliary air chamber member.

FIG. 3 is an enlarged vertical sectional view taken along the line III-III in FIG. 1.

FIG. 4 is a partially cutaway side view of a circumferential end of the auxiliary air chamber member shown in FIG. 1 seen in a wheel circumferential direction.

FIG. 5 is a partially abbreviated enlarged vertical sectional view taken along a line V-V in FIG. 4.

FIGS. GA and 6B are diagrams showing a first modification of the present embodiment. FIG. 6A is an enlarged vertical sectional view of a first modification corresponding to FIG. 3, and FIG. 6B is a partially cutaway side view of a first modification corresponding to FIG. 4.

FIG. 7A is an enlarged diagram of a partially cutaway perspective view of an auxiliary air chamber member according to a second modification, FIG. 7B is an enlarged diagram of a partially cutaway perspective view of an auxiliary air chamber member according to a third modification.

FIG. 8 is a diagram showing a modification of a conventional art devised by an applicant of the present application, and an explanatory view showing a positional relationship between a bead portion of a tire and a tube displaced outward in a wheel radial direction.

### DESCRIPTION OF EMBODIMENTS

Next, an embodiment of the present invention is described in detail with reference to the drawings as appropriate.

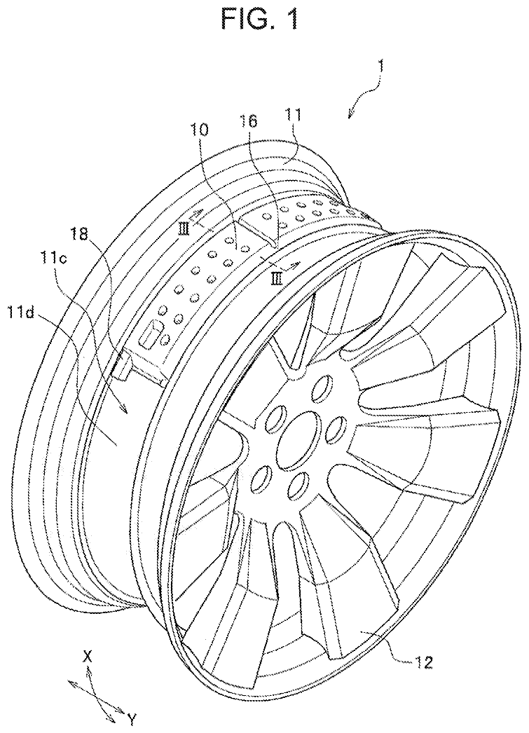

FIG. 1 is a perspective view of a vehicle wheel. according to an embodiment of the present invention. In each of the drawings, “X” indicates a wheel circumferential direction, “Y” indicates a wheel width direction, and “Z” indicates a wheel radial direction. In addition, in the wheel width direction “Y”, its inside direction is indicated. as “a first side” and its outside direction is indicated as “a second side”.

As shown in FIG. 1, the vehicle wheel 1 according to the present embodiment includes an auxiliary air chamber member 10 as a Helmholtz resonator along the wheel circumferential axis X. Incidentally, the present embodiment is assumed that a plurality of auxiliary air chamber members 10 are placed along the wheel circumferential axis X of the vehicle wheel 1, however. FIG. 1 shows only a single auxiliary air chamber member 10 placed along the wheel circumferential axis X, and other auxiliary air chamber members 10 are not illustrated.

The vehicle wheel 1 includes a rim 11 and a disk 12 connecting the rim 11 to a hub (not shown). The auxiliary air chamber member 10 is fitted and mounted. on an outer peripheral. surface (wheel rim surface) 11d of a well portion 11c.

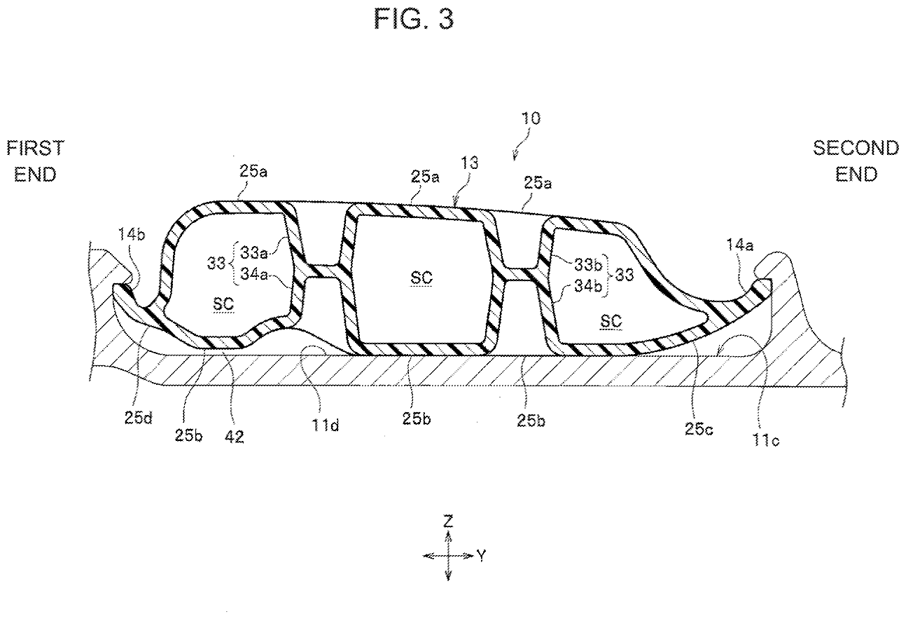

The rim 11 includes a well portion 11c between bedsheets (not shown) formed at both ends in the wheel width direction Y, and the well portion 11c is depressed inward (toward a rotation center direction) in the wheel radial axis Z (see FIG. 3 described below).

The well portion 11c is provided to insert thereinto a bead portion (not shown) of the tire when the tire (not shown) is fitted into the rim 11 over the wheel width direction Y. Note that the well portion 11c of the present embodiment is formed in a cylindrical shape having substantially an equal diameter across the wheel width

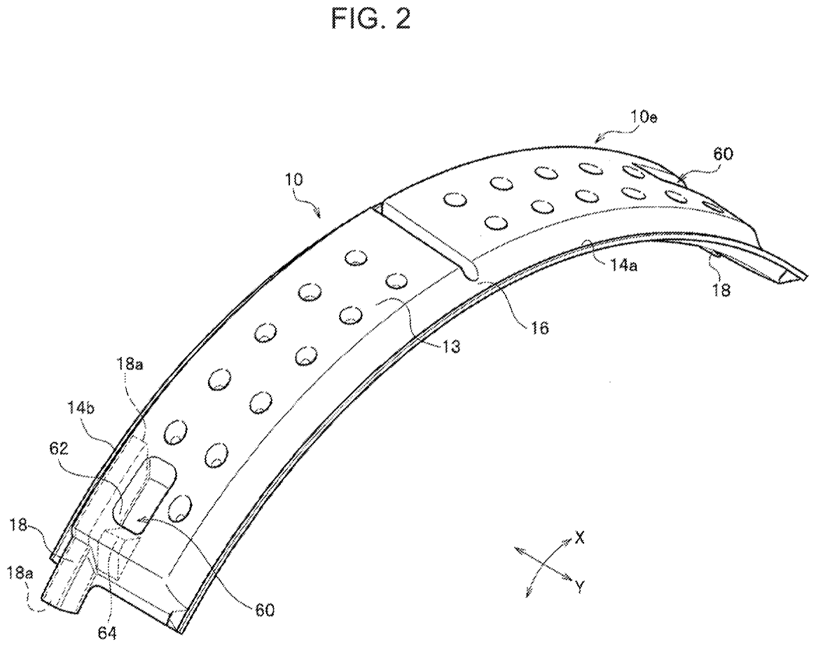

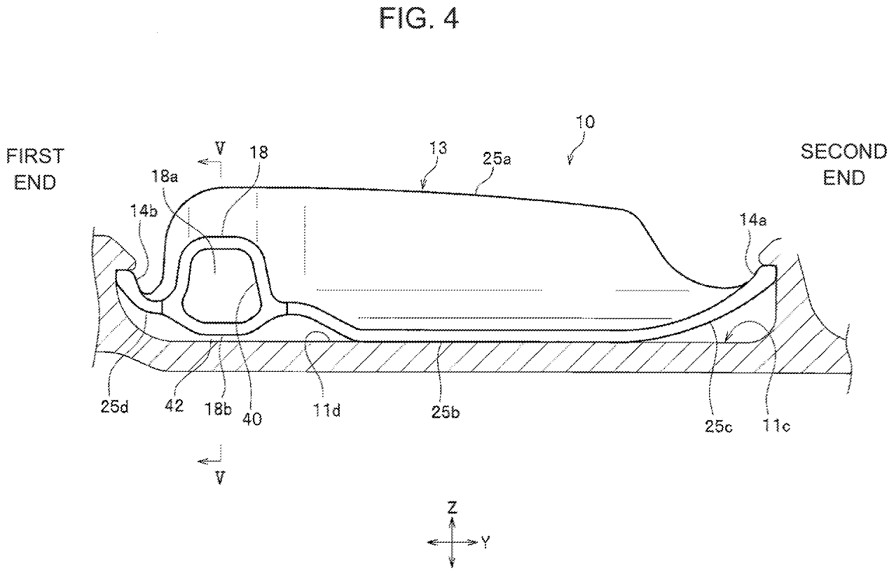

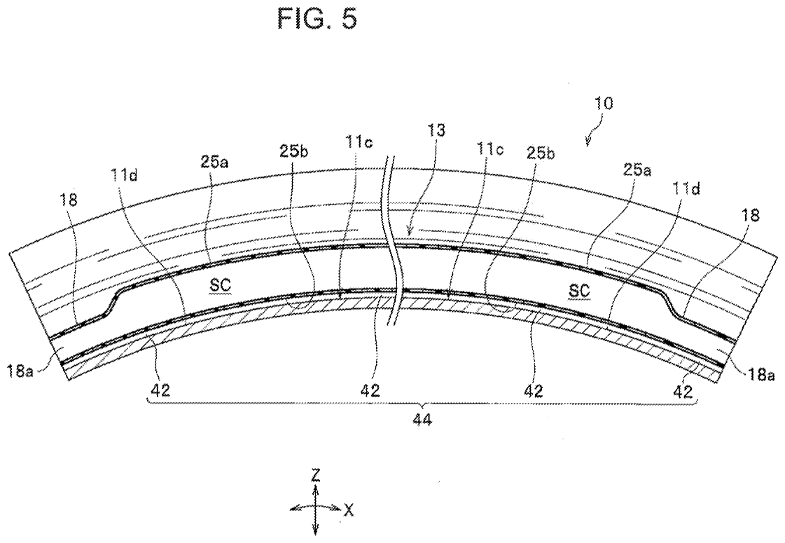

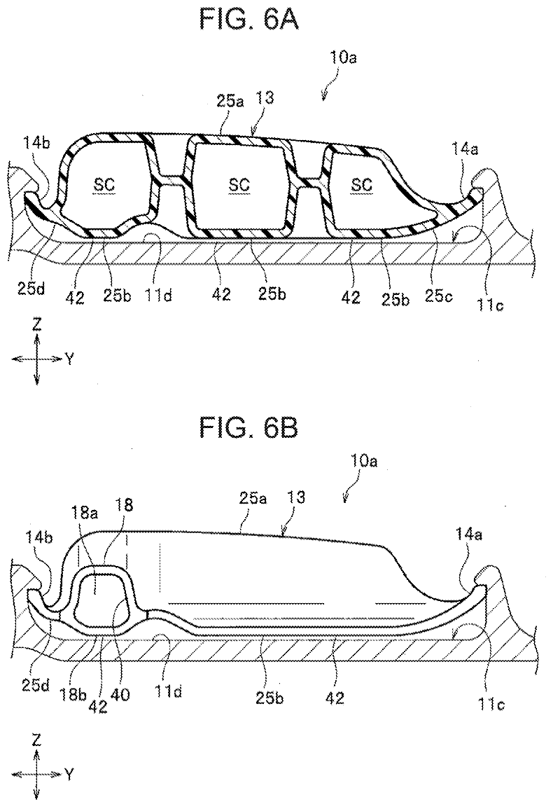

FIG. 2 is a perspective view of the auxiliary air chamber member; FIG. 3 is an enlarged vertical sectional view taken along the line III-III in FIG. 1; FIG. 4 is a partially cutaway side view of a circumferential end of the auxiliary air chamber member shown in FIG. 1 seen in a wheel circumferential direction; FIG. 5 is a partially abbreviated enlarged vertical sectional view taken along a line V-V in FIG. 4.

As shown in FIG. 2, the auxiliary air chamber member 10 is longitudinal along one line, and includes a hollow main body 13 including therein an auxiliary air chamber SC (see FIG. 3) described below and a pair of end portions 14a and 14b, which catch the auxiliary air chamber member 10 on the well portion 11c (see FIG. 3). The auxiliary air chamber SC included in the main body 13 is formed to be separated into a pair of independent auxiliary air chambers SC with an interposition of a partition wall 16 (see FIGS. 1 and 2) disposed at a center in the wheel circumferential axis X.

The auxiliary air chamber member 10 is curved along its longitudinal axis, and configured to extend along the wheel circumferential axis X when attached to the outer peripheral surface 11d of the well portion 11c (see FIG. 1). The main body 13 is provided with a tube 18 at an end in the longitudinal axis (wheel circumferential axis X), and a communication hole 18a communicating with the auxiliary air chamber SC formed within the tube 18 (see FIGS. 1, 2, and 4). The communication hole 18a allows the tire air chamber (not shown) to communicate with the auxiliary air chamber SC. The tube 18 having the communication hole 18a is disposed at each of both ends of a first and a second ends included in the auxiliary air chamber member 10 in its wheel circumferential axis X (see FIG. 2). Further, the pair of tubes 18 disposed at both of the ends in the wheel circumferential axis X are respectively disposed at portions biased to the inner corner (the first end) in the wheel width direction Y (see FIG. 4).

Note that description is given of the communication hole 18a disposed at the first end In the present embodiment and description is omitted of the communication hole 18a disposed at the second end, because the communication boles 18a provided at the first and second ends in the wheel circumferential axis X are configured in the same manner as each other.

As shown in FIG. 2, the auxiliary air chamber member 10 exhibits a long rectangular shape in a plan view. And as shown in FIG. 3, the main body 13 of the auxiliary air chamber member 10 includes a lower surface portion 25b, an upper surface portion 25a, and an auxiliary air chamber SC. The lower surface portion 25b is formed of a bottom plate disposed at a direction facing the outer peripheral surface 11d (see FIG. 1) of the well portion 11e. The upper surface portion 25a is formed of an upper plate that is disposed more outward in a radial axis than the lower surface portion 25b and faces the lower surface portion 25b. The auxiliary air chamber SC is formed between the upper and lower surface portions 25a and 25b.

As shown in FIG. 4, a first side wall 25c as a first vertical wall is formed at the inner corner (the second end) along the wheel width direction Y between the upper surface portion 25a and the lower surface portion 25b. At the outer corner (the first end) along the wheel width direction Y, a second side wall 25d as a second vertical wall is formed. The first side wall 25c and the second side wall 25d are disposed opposite to each other in the wheel width direction Y.

Further, as shown in FIG. 3, the main body 13 of the auxiliary air chamber member 10 has the lower surface portion 25b and the upper surface portion 25a connected to each other at both ends in the width direction Y and has a first edge 14a and a second edge 14b engaged with the well portion 11c. Furthermore, the main body 13 of the auxiliary air chamber member 10 is provided with coupling portions 33, at which the main body 13 is depressed into an inner portion of the auxiliary air chamber SC respectively from the upper surface portion 25a and the lower surface portion 25b to partially couple the upper surface portion 25a and the lower surface portion 25b.

The upper surface portion 25a is located above the lower surface portion 25b arranged along on the outer peripheral surface 11d of the well portion 11c, and forms an auxiliary air chamber SC by being curved so as to have a bulge.

The upper surface portion 25a has thereon a pair of upper coupling portions 33a. and 33b formed in a part of the main body 13 along the wheel width direction Y. The pair of upper coupling portions 33a and 33b include an upper coupling portion 33a near the first end (inward) along the wheel width direction Y and an upper coupling portion 33b near the second end (outward) along the wheel width direction Y. The pair of upper coupling portions 33a and 33b are formed by depressing the upper surface portion 25a toward the lower surface portion 25b in a shape of a circular shape in a plan view. Multiple pairs of upper coupling portions 33a and 33b are arranged in the width direction of the main body 13 to form two rows each along the longitudinal direction (the wheel circumferential axis X) of the auxiliary air chamber member 10.

The lower surface portion 25b has a pair of lower coupling portions 34a and 34b formed at positions corresponding to the pair of upper coupling portions 33a and 33b. The upper coupling portions 33a and 33b and the lower coupling portions 34a and 34b together constitute a coupling portion 33. The lower coupling portions 34a and 34b are formed by depressing the lower surface portion 25b toward the upper surface portion 25a in a circular shape when viewed from a bottom. The lower coupling portions 34a and 34b have their distal ends integrated with the distal ends of the upper coupling portions 33a and 33b of the upper surface portion 25a to partially couple the upper surface portion 25a and the lower surface portion 25b.

The upper coupling portions 33a and 33b and the lower coupling portions 34a and 34b mutually connected in the auxiliary air chamber SC improve a mechanical strength of the auxiliary air chamber member 10 and suppresses fluctuation of volume of the auxiliary air chamber SC to exert a noise reduction function.

Furthermore, as shown in FIG. 2, the auxiliary air chamber member 10 has a pair of rectangular recesses 60 formed respectively portions adjacent to the tubes 18 at the first and second ends along the wheel circumferential axis X of the main body 13. Each of the rectangular concave portions 60 has the same configuration, which exhibits a rectangular recess having a vertically long rectangular shape in a plan view and a recess from the upper surface portion 25a toward the lower surface portion 25b. This rectangular recess 60 is located outside (the first end) in the wheel width direction Y and has a vertical wall 62 extending along the wheel circumferential axis X. The vertical wall 62 is formed so as to make a part of the communication hole 18a of the tube 18 extend in the wheel circumferential axis X in the main body 13. In addition, recesses 64 are formed at positions adjacent to the rectangular recesses 60 close to the tube bodies 18, which recesses 64 are formed to be recessed from the lower surface portion 25b toward the upper surface portion 25a, contrary to the above recesses 64. The recesses 64 are disposed at the first and second ends along the wheel circumferential axis X of the main body 13.

The communication hole 18a of the tube 18 arranged at the end of the body 13 in the wheel circumferential axis X communicates with the auxiliary air chamber SC at the first end of the tube 18 in the wheel circumferential axis X, and is open to an outside (tire air chamber) at the second end of the tube 18 in the wheel circumferential axis X. The tube 18A has at its distal end in the wheel circumferential axis X a substantially rectangular opening 40 formed in a substantially a rectangular shape as shown in. FIG. 4. In addition, a clearance 42 is formed between the communication hole 18a and the outer peripheral surface lid of the well portion 11c of the vehicle wheel 1.

In other words, the bottom end 18b of the end of the tube 18 in the wheel circumferential axis X is in non-contact with the outer peripheral surface 11d of the well portion 11c of the vehicle wheel 1 so that the clearance 42 is formed between the bottom end 18b of the tube 18 and the outer peripheral surface 11d of the well portion 11c with the surface 11d. This forming of the clearance 42 provides a step in the wheel radial axis Z between the communication hole 18a of the tube 18 and the outer peripheral surface 11d of the well portion 11e. Note that the clearance 42 is preferably 0.5 mm or more in size, but not limited to this size.

As shown in FIG. 5, the clearance 42 is formed continuously from the first end to the second end in the wheel circumferential axis X by the pair of tubes 18 and the main body 13. Continuously extending the clearance 42 from the one tube 18 to the other tube 18 along the wheel circumferential axis X forms a water passage 44 through which water, moisture, and the like flow. In the present embodiment shown in FIGS. 4 and 5, the clearance 42 is not formed on other part of the main body 13 except the lower surface portion 25b on the first end of the tube 18 and the main body 13, due to a contact of the lower surface portion 25b of the main body 13 with the outer peripheral surface 11d of the well portion 11c. Further, the clearance 42 may be partially formed at only a section of the tube 18 having the communication hole 18a along the wheel circumferential axis X. This may minimize a reduction in a volume of the auxiliary air chamber SC, and provides a noise reduction effect equivalent to that of a conventional auxiliary air chamber member having no clearance 42.

FIG. 6 shows a first modification of the auxiliary air chamber member 10, in which. FIG. 6A is an enlarged vertical sectional view of the first modification corresponding to FIG. 3 of the embodiment, and FIG. 6B is a partially cutaway side view of the first modification corresponding to FIG. 4 of the embodiment.

As shown in FIGS. 6A and 6B, the auxiliary air chamber member 10a according to the first modification has the bottom end 18b of the tube 18 and all over the lower surface portions 25b of the main body 13 including the first and second end being in non-contact with the outer peripheral surface 11d of the well portion 11c.

That is, the clearance 42 is continuously formed all over the wheel width Y between the tube 18 and the whole surface of the main body 13 including the first and second ends and the outer peripheral surface 11d of the well portion 11c of the vehicle wheel 1. Note that continuous forming of the clearance 42 from the first end to the second end along the wheel circumferential axis Xis the same as that of the embodiment shown in FIGS. 3 and 4.

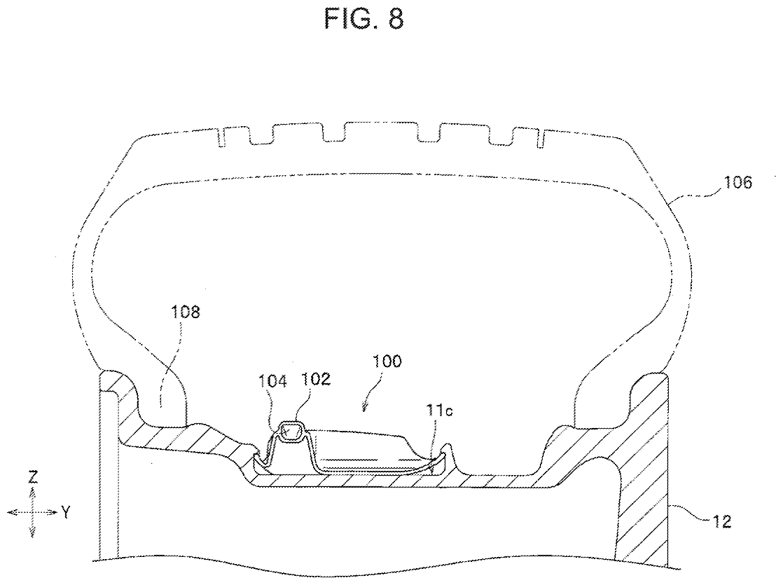

For an example enhancement of the conventional art, as shown in FIG. 8, it may be able to be thought of securing the clearance by displacing the tube 102 of the conventional auxiliary air chamber member 100 toward the outside along the wheel radial axis Z. However, in the above enhancement, if a position of the communication hole 104 of the pipe 102 is displaced outward. in the wheel radial axis Z, this moves the communication hole 104 of the pipe 102 closer to the bead portion 108 of the tire 106 resulting a possible interference of the communication hole 104 with the bead portion 108. On the contrary, in the auxiliary air chamber member 10a according to the first modification, increasing the clearance amount along the wheel width direction Y is able to reduce the displacement amount by which the tube 18 is displaced outward along the wheel radial axis Z, so that interference of the tire 106 with the bead portion 108 (see FIG. 8) may be able to be suitably avoided.

The vehicle wheel 1 according to the present embodiment is fundamentally configured as described above. Then, description is given of an effect of the present embodiment.

The present embodiment provides the clearance 42 between the outer peripheral surface 11d of the well portion 11c and the bottom end 18b of the tube 18 having the communication hole 18a. This makes the step along the wheel radial axis Z between the outer peripheral surface 11d of the well portion 11c and the communication hole 18a (see FIG. 4). Therefore, the present embodiment is able to prevent, for example, the water condensed in the tire air chamber, moisture, and a liquid of a puncture repair agent from entering the communication hole 18a through the outer peripheral surface 11d of the well portion 11c.

In other words, the present embodiment, the communication hole 18a of the tube 18 is arranged at a position apart from the outer peripheral surface 11d (wheel rim surface) of the well portion 11c outward along the wheel radial axis Z. This allows the present embodiment to prevent water, moisture, and the like in the tire air chamber from entering and remaining in the auxiliary air chamber SC.

This results in the suitable and reliable avoidance of the decrease in the volume of the auxiliary air chamber SC of the auxiliary air chamber member 10 caused by the entering of the water or the like into the auxiliary air chamber SC and the reduced performance of the noise reduction; i.e., performance deterioration of the road noise reduction caused by air column resonance, in the present embodiment. Further, the present embodiment is able to suitably prevent the water, moisture, or the like from remaining in the auxiliary air chamber SC, and therefore to prevent a wheel balance from being deteriorated due to the remaining moisture.

Further, in the present embodiment, the clearance 42 is continuously formed to extend from the first end at which the communication hole 18a is disposed to the second end of the auxiliary air chamber member 10 along the wheel circumferential axis X of the vehicle wheel 1 (see FIG. 5). Specifically, the clearance 42 extends continuously from the first end of the tube 18 disposed at the first end of the auxiliary air chamber member 10 along the wheel circumferential axis X to the second end of the tube 18 disposed at the second end of the auxiliary air chamber member 10 to form a water passage 44 along the wheel circumferential axis X. This allows the present embodiment to make water, moisture, and the like circulate along the water channel 44 without accumulating at a position on the outer peripheral surface 11d of the well portion 11c at which the tube 18 having the communication hole 18a is arranged.

Further, the present embodiment is able to disperse and scatter the water, moisture, and. the like flowing along the water channel 44 toward the tire (not shown) without making them remain on the outer peripheral surface 11d of the well portion 11c by an act from a centrifugal force of the rotating tire. As a result, the present embodiment is able to prevent the water, moisture, and the like from entering the auxiliary air chamber SC, and to appropriately prevent the noise reduction performance from being deteriorated.

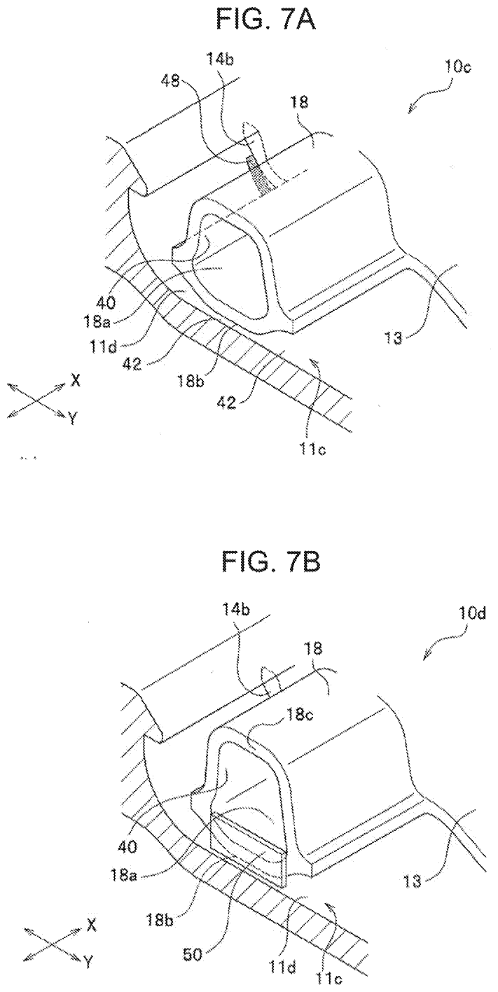

Next, description is given of a second modification of the auxiliary air chamber member shown in FIG. 7. FIG. 7A is an enlarged partially cutaway perspective view of an auxiliary air chamber member according to a second. modification, and. FIG. 7B is an enlarged partially cutaway perspective view of an auxiliary air chamber member according to a third modification.

The auxiliary air chamber member 10c shown in. FIG. 7A differs from the first modification in that the member 10c includes an intermediate plate 48 that works as a spacer and is located between the tube 18 and the edge portion 14b along the wheel width direction Y and on the outer peripheral surface lid of the well portion 1c. The intermediate plate 48 is formed by a band-shaped plate extending in the wheel circumferential axis X, and able to easily form the clearance 42 by being interposed between the edge portion 14b and the outer peripheral surface 11d of the well portion 11c, which is an advantage of the intermediate plate 48.

The auxiliary air chamber member 10d shown in FIG. 7B differs from the embodiment in that the member 10d is provided with an upright shielding plate 50 that is a wall formed to cover a lower part of the opening 40 of the tube 18 for preventing the water, moisture, or the like from entering the communication hole 18a. The auxiliary air chamber member 10d is not provided with the clearance 42 between the bottom end 18b of the tube 18 and the outer peripheral surface 11d of the well portion 11c. This provides an advantage that the auxiliary air chamber member 10d is able to stabilize seating of the main body 13 on the outer peripheral surface 11d of the well portion 11c as compared with the case where the clearance 42 is provided.

A cross-sectional area of the opening of the communication hole 18a of the tube 18 affects the resonance frequency. Therefore, the auxiliary air chamber member 10d shown in FIG. 7B needs to be designed on the cross-sectional area of the opening of the communication hole 18a and the shielding plate 50 so as to have the target resonance frequency maintained. In order to obtain a desired resonance frequency, the cross-sectional area of the opening of the communication hole 18a of the tube 18 and a length of the communication hole 18a are to be appropriately adjusted on an assumption that the shield plate 50 is mounted.

1. A vehicle wheel comprising:
an auxiliary air chamber member as, a Helmholtz resonator, the auxiliary air chamber member attached on an outer peripheral surface of a well portion in a tire air chamber,
a first vertical wall provided at a first rising portion of a rim forming the well portion; and
a second vertical wall provided at a second rising portion of the rim,
wherein
the auxiliary air chamber member includes:
an auxiliary air chamber inside thereof, and
a communication hole allowing the auxiliary air chamber to communicate with the tire air chamber, the communication hole being placed at a first end of the of the auxiliary air chamber member along a circumferential axis of the vehicle wheel,
and wherein a clearance is formed between the communication hole and the vehicle wheel and extends continuously from the first end at which the communication hole is placed to a second end of the auxiliary air chamber member along a circumferential axis of the vehicle.

2. (canceled)

3. The vehicle wheel according to claim 1
wherein the clearance is provided only in a partial area at which the communication hole is placed along the circumferential axis of the vehicle wheel.

4. The vehicle wheel according to claim 1,
wherein the communication hole is disposed at each of ends of the auxiliary air chamber member along a circumferential axis of the vehicle wheel.

5. The vehicle wheel according to claim 1,
further comprising:
an edge portion catching the auxiliary air chamber member on the well portion, and
a tube including the communication hole,
wherein an intermediate plate is provided on the outer peripheral surface of the well portion, and the intermediate plate is located between the edge portion and the tube along a wheel width of the vehicle wheel.
